(19) United States
(12) Patent Application Publication
(10) Pub. No.: US 2024/0222883 A1
(43) Pub. Date: Jul. 4, 2024

(54) Connecting Terminal and Electrical Connector

(71) Applicant: Tyco Electronics (Shanghai) Co., Ltd., Shanghai (CN)

(72) Inventors: YuQiang (Thomas) Zhao, Shanghai (CN); Qianjin (Orando) Li, Shanghai (CN)

(73) Assignee: Tyco Electronics (Shanghai) Co., Ltd., Shanghai (CN)

(21) Appl. No.: 18/399,824

(22) Filed: Dec. 29, 2023

(30) Foreign Application Priority Data
Dec. 30, 2022 (CN) 202211724032.7

(51) Int. Cl. H01R 4/02

(52) U.S. Cl. CPC H01R 4/023

(57) ABSTRACT

A connecting terminal includes a planar main body having an electrical contacting portion, and a welding portion. The electrical contacting portion is adapted to be in electrical contact with a mating terminal. The welding portion is connected to the electrical contacting portion and is adapted to be welded to at least one cable.

### CROSS-REFERENCE TO RELATED APPLICATION

This application claims the benefit of Chinese Patent Application No. CN 202211724032.7 filed on Dec. 30, 2022, in the State Intellectual Property Office of China, the whole disclosure of which is incorporated herein by reference.

### FIELD OF THE INVENTION

Embodiments of the present disclosure generally relate to a connecting terminal, and in particular, to a connecting terminal for connecting a cable to other wiring terminal(s), and an electrical connector including such connecting terminal.

### BACKGROUND

In order to provide power to an electronic device, a cable needs to be connected to a wiring terminal of the device. For example, FIG. 1 shows a perspective schematic view of a connecting terminal 200 which connects the cable 300 to the wiring terminal of the electronic device in the related art. The connecting terminal 200 includes a riveting portion 201 for riveting the cable, a holding portion 202 for holding the cable, and an electrical contacting portion 203 for connecting to the wiring terminal of the electronic device. The connecting terminal 200 has a U-shaped structure as a whole, but typically can only be riveted to one cable. As a result, the current-carrying capacity of the entire connecting terminal is relatively poor. In addition, the structure of the connecting terminal is unnecessarily complicated, and the number of the required manufacturing molds is large, the manufacturing process is complicated, and the manufacturing cost is high.

### SUMMARY

According to an embodiment of the present disclosure, a connecting terminal includes a planar main body having an electrical contacting portion, and a welding portion. The electrical contacting portion is adapted to be in electrical contact with a mating terminal. The welding portion is connected to the electrical contacting portion and is adapted to be welded to at least one cable.

### BRIEF DESCRIPTION OF THE DRAWINGS

The invention will now be described by way of example with reference to the accompanying Figures, of which:

FIG. 1 is a schematic view of the connection between a connecting terminal and a cable according to the related art;

FIG. 2 is a schematic perspective view of a connecting terminal according to an exemplary embodiment of the present disclosure;

FIG. 3 is a schematic view of the connection between a connecting terminal and a cable according to an exemplary embodiment of the present disclosure;

FIG. 4 is a schematic view of the connection between a connecting terminal and cables according to another exemplary embodiment of the present disclosure;

FIG. 5 is a schematic view of the connection between connecting terminals and cables according to yet another exemplary embodiment of the present disclosure;

FIG. 6 is a schematic view of the connection between connecting terminals and cables according to still another exemplary embodiment of the present disclosure;

FIG. 7 is a schematic view of connecting terminals and cables according to an exemplary embodiment of the present disclosure, showing a terminal locking member;

FIG. 8 is a perspective view of a terminal locking member for a connecting terminal according to an exemplary embodiment of the present disclosure;

FIG. 9 is a perspective schematic view of an electrical connector according to an exemplary embodiment of the present disclosure; and

FIG. 10 is a cross-sectional schematic view of an electrical connector according to an exemplary embodiment of the present disclosure.

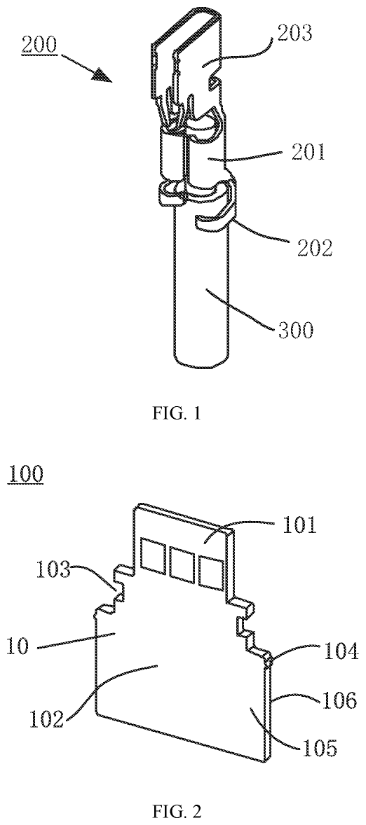

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connecting terminal includes a main body having a planar structure. The main body defines an electrical contacting portion configured to be in electrical contact with a mating terminal, and a welding portion connected to the electrical contacting portion and adapted to weld together with at least one cable.

According to another embodiment of the present disclosure, an electrical connector includes a connecting terminal and an insulating housing within which the connecting terminal is located. A main body of the connecting terminal has a planar structure. The main body defines an electrical contacting portion adapted to be in electrical contact with a mating terminal, and a welding portion connected to the electrical contacting portion and adapted to weld to at least one cable.

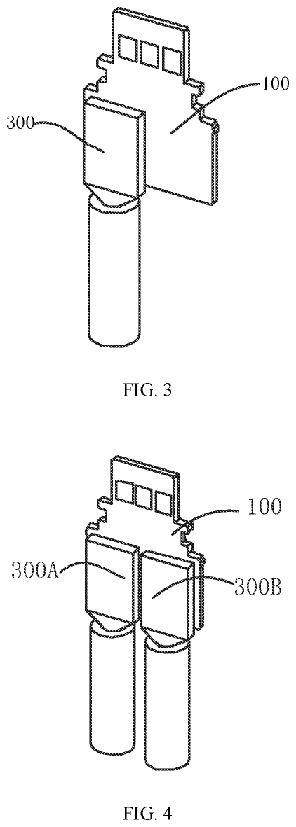

FIG. 2 is a schematic perspective view of a connecting terminal according to an exemplary embodiment of the present disclosure. As shown in FIG. 2, the connecting terminal 100 includes a main body 10 made of a plate of a conductive material such as copper. The main body 10 has a planar structure, and the main body 10 includes an electrical contacting portion 101 and a welding portion 102 connected to the electrical contacting portion 101. The electrical contacting portion 101 is configured to be in electrical contact with a mating terminal, and the welding portion 102 is configured to weld together with at least one cable 300, as shown in FIGS. 3-6. The connecting terminal 100 can connect the cable 300 to the wiring terminal of the electrical device to provide a high current signal (such as a power signal) to the electrical device via the cable 300. The connecting terminal 100 according to the embodiments of the present disclosure can transmit large current signals by directly welding the at least one cable 300 onto the welding portion 102 of the connecting terminal. In addition, the structure of the connecting terminal 100 is relatively simple and the number of the required manufacturing molds is small, the manufacturing process is simple, and the manufacturing cost is low.

In the exemplary embodiment shown in FIG. 2, the main body 10 has a first face 105 and an opposite second face 106. The at least one cable 300 may be welded either to the first face 105, or to the second face 106, or to both the first face 105 and the second face 106. In the exemplary embodiment as shown in FIG. 2, the connecting terminal 100 can be an integral conductive component formed by stamping a single metal plate. This can not only reduce the manufacturing cost, but also simplify the manufacturing process.

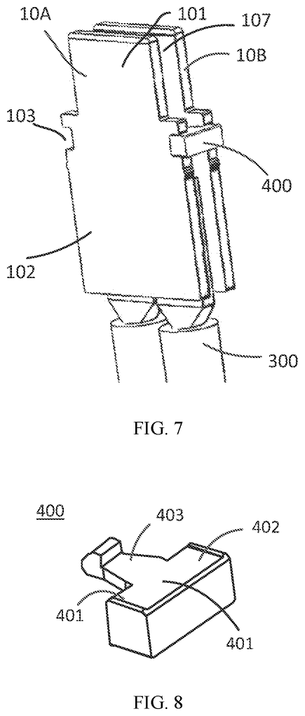

In the exemplary embodiment as shown in FIGS. 2 and 7, opposite two sides of the main body 10 are formed with a notch 103, respectively. The notch 103 is located between the welding portion 102 and the electrical contacting portion 101. The notch 103 is configured to fit with a terminal locking member 400 of an electrical connector for locking the connecting terminal 100 (as shown in FIG. 10), so as to prevent the connecting terminal 100 from moving in a direction opposite to an insertion direction of the connecting terminal 100. In this way, the connecting terminal 100 can be retained in an insulating housing 500 of the electrical connector by fitting the notch 103 of the connecting terminal 100 with the terminal locking member 400 of the electrical connector. It should be noted that, in some other embodiments of the present disclosure, the notch 103 may also be formed only on one side of the main body 10.

In the exemplary embodiment as shown in FIG. 2, opposite two sides of the main body 10 are formed with a positioning protrusion 104 protruding outward, respectively. The positioning protrusion 104 is formed on a side of the welding portion 102 close or proximate to the electrical contacting portion 102. The positioning protrusion 104 is configured to interfere or engage with the insulating housing 500 accommodating the connecting terminal 100 (as shown in FIG. 10), so that the insulating housing 500 is engaged with this positioning protrusion 104 to initially position the connecting terminal 100 during the assembly of the connecting terminal 100 into the insulating housing 500 of the electrical connector.

FIG. 3 is a schematic view of the connection between a connecting terminal and a cable according to an exemplary embodiment of the present disclosure. In the embodiment as shown in FIG. 3, the connecting terminal 100 includes one main body 10 and one cable 300, wherein a conductor portion of the one cable 300 is welded directly to the welding portion 102 of the connecting terminal. Specifically, when welding the cable 300 to the welding portion 102, an outer protective layer of the cable at its connecting end is first stripped to expose the conductor portion of the cable 300. Next, the conductor portion of the cable 300 is welded onto the welding portion 102 of the main body 10 of the connecting terminal 100.

FIG. 4 is a schematic view of the connection between a connecting terminal and cables according to another exemplary embodiment of the present disclosure. In the embodiment as shown in FIG. 4, the connecting terminal 100 includes one main body 10 and two cables 300A, 300B. The two cables 300A, 300B are welded directly, side by side, onto the welding portion 102. In this embodiment, the two cables 300A, 300B are all welded onto a first face 105 of the main body 10. It should be noted that, in some other embodiments of the present disclosure, the two cables are 300A, 300B can also be welded directly, side-by-side, onto a second face 106 of the main body 10, or one cable is welded onto the first face 105 of the main body 10 and the other cable is welded onto the second face 106 of the main body 10. Although in the embodiments shown in FIGS. 3 and 4 the number of the welded cables 300 is one or two, it should be noted that in some other embodiments of the present disclosure, the number of the cables 300 may also be three, four and the like.

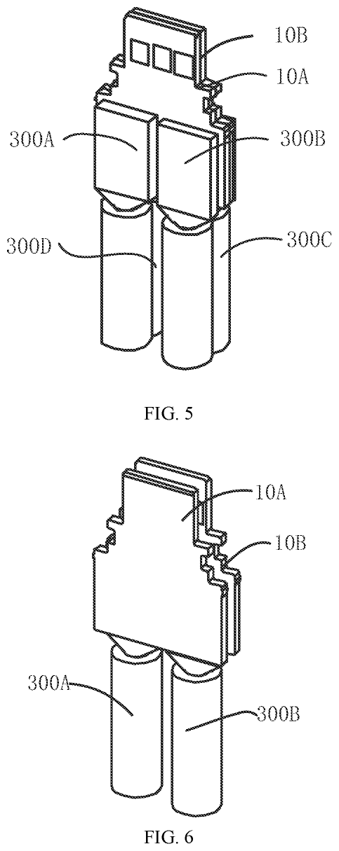

FIG. 5 is a schematic view of the connection between connecting terminals and cables according to yet another exemplary embodiment of the present disclosure. In the exemplary embodiment, the connecting terminal 100 includes two main bodies 10A, 10B. The two main bodies 10A, 10B are stacked together in a direction perpendicular to a plane where the main bodies are located. Four cables 300A, 300B, 300C, 300D are welded onto a face of either one 10A, 10B of the two main bodies located away from the other one 10B, 10A, of the two main bodies, respectively. Specifically, in this embodiment, the second faces of the two main body 10A, 10B are tightly abutted together, two cables 300A, 300B are welded onto the first face 105 of one main body 10A, and the other two cables 300C, 300D are welded onto the first face 105 of the other main body 10B.

It should be noted that, in the exemplary embodiments of the present disclosure, the number of the main bodies may also be three or more, and the plurality of main bodies is tightly abutted together in the direction perpendicular to the plane in which the main bodies are located. One or more cables are welded onto a face of the outermost main body of the plurality of main bodies located away from the other main bodies of the plurality of main bodies. According to the connecting terminal of the present disclosure, the current-carrying capacity of the connecting terminal can be further increased by adopting the plurality of main bodies stacked together.

FIG. 6 is a schematic view of the connection between connecting terminals and cables according to still another exemplary embodiment of the present disclosure. In the exemplary embodiment, the connecting terminal 100 includes two main bodies 10A, 10B. The two main bodies 10A, 10B are stacked together in a direction perpendicular to a plane where the main bodies are located. The two cables 300A, 300B are welded between the two main bodies 10A, 10B. Specifically, the two cables 300A, 300B are welded onto the first face 105 of one main body 10A and are also welded onto the first face 105 of the other main body 10B. In embodiments not shown of the present disclosure, the number of cables may also be one or more. In the illustrated embodiment, when at least one cable is welded between the two main bodies 10A, 10B, an insertion slot 107 for insertion of the mating terminal is formed between the electrical contacting portions 101 of the two main bodies 10A, 10B.

It should be noted that, in exemplary embodiments of the present disclosure, the number of the main bodies may also be three or more, and the plurality of main body is stacked together in the direction perpendicular to the plane where the main bodies are located, and at least a portion of the at least one cable is welded between any adjacent two main bodies of the at least two main bodies.

In exemplary embodiments of the present disclosure, at least a portion of the at least one cable is welded onto a face of the outermost main body 10A, 10B of the plurality of main bodies away from the other main bodies 10B, 10A. Specifically, for example, in the exemplary embodiment as shown in FIG. 6, a cable can also be welded onto the face of the main body 10A away from the other main body 10B, and/or onto the face of the second main body 10B away from the first main body 10A. This further increases the current-carrying capacity of the connecting terminal.

FIG. 7 is a schematic view of connecting terminals and cables according to an exemplary embodiment of the present disclosure. As shown in FIG. 7, the connecting terminal 100 includes two main bodies 10A, 10B. The two main bodies 10A, 10B are stacked together in the direction perpendicular to the plane in which the main bodies are located. Two cables 300A, 300B are welded between the two main bodies 10A, 10B. Opposite two sides of the main bodies 10A, 10B are formed with a notch 103 located between the welding portion 102 and the electrical contacting portion 101, respectively. The notch 103 is adapted to fit with a terminal locking member 400 (as shown in FIG. 10) of the electrical connector, so as to prevent the connecting terminal 100 from moving in the direction opposite to the insertion direction of the connecting terminal 100. In this way, the connecting terminal 100 may be maintained in the insulating housing 500 of the electrical connector by fitting the notch 103 of the connecting terminal 100 with the terminal locking member 400 of the electrical connector.

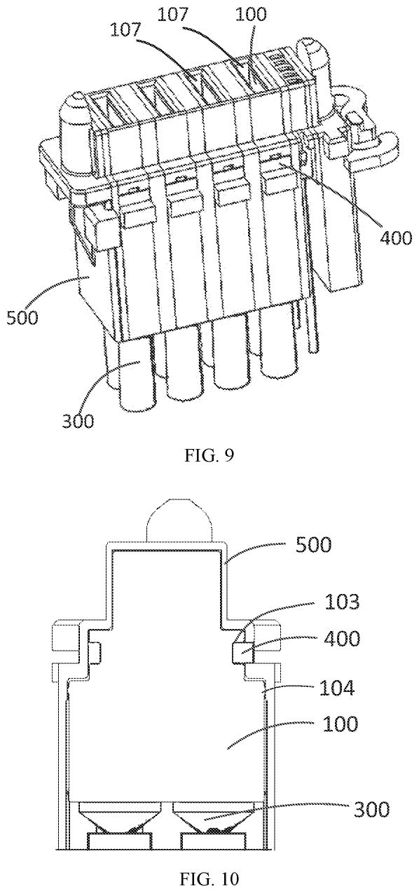

According to embodiments of another aspect of the present disclosure, there is provided an electrical connector for connecting a cable to a wiring terminal of an electronic device. As shown in FIGS. 9 and 10, the electrical connector includes an insulating housing 500 made of an insulating material such as plastic, and at least one connecting terminal 100 as described in the forgoing various embodiments. The connecting terminal 100 is mounted within the insulating housing 500.

In one exemplary embodiment of the present disclosure as shown in FIGS. 7 and 10, the connecting terminal 100 further includes the terminal locking member 400 configured to fit with the notch 103 of the two main bodies 10A, 10B. This arrangement prevents the connecting terminal 100 from moving in the direction opposite to the insertion direction of the connecting terminal 100. In this way, the connecting terminal 100 may be maintained in the insulating housing 500 of the electrical connector by fitting the notch 103 of the connecting terminal 100 with the terminal locking member 400 of the electrical connector.

FIG. 8 is a perspective view of a terminal locking member for a connecting terminal according to an exemplary embodiment of the present disclosure. As shown in FIG. 8, the terminal locking member 400 includes a base 401 and protrusions 402 extending outward from either end of the base 401. The two protrusions 402 are configured to fit with the notches 103 of the adjacent two main bodies 10A, 10B of the connecting terminal 100 to maintain the connecting terminal 100 within the insulating housing 500 of the electrical connector. In addition, the terminal locking member 400 further includes a spacing portion 403 extending from the base portion 401 and perpendicular to the base portion 401. In case that the connecting terminal 100 includes two main bodies 10A, 10B and the at least one cable is welded between the two main bodies 10A, 10B, when the terminal locking member 400 is assembled with the connecting terminal 100, the spacing portion 403 is positioned between the two main bodies 10A, 10B to improve the stability of the connecting terminal.

In one exemplary embodiment of the present disclosure, as shown in FIGS. 7 and 9, when the at least one cable is welded between two adjacent main bodies 10A, 10B, an insertion slot 107 for insertion of the mating terminal is formed between the electrical contacting portions of the two main bodies 10A, 10B. In one exemplary embodiment of the present disclosure, as shown in FIG. 9, the number of the insertion slots 107 is greater than one.

According to the connecting terminal and the electrical connector provided by the foregoing exemplary embodiments of the present disclosure, the connecting terminal can transmit large current signals by directly welding one or more cables onto the welding portion of the connecting terminal. In addition, the structure of the connecting terminal is simplified, and the number of the required manufacturing molds is small, the manufacturing process is simple, and the manufacturing cost is low.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connecting terminal, comprising:
a planar main body, including:
an electrical contacting portion adapted to be in electrical contact with a mating terminal; and
a welding portion connected to the electrical contacting portion and adapted to be welded to at least one cable.

2. The connecting terminal according to claim 1, wherein the main body has a first face and an opposite second face, and the at least one cable is weldable onto at least one of the first face or the second face.

3. The connecting terminal according to claim 2, further comprising a plurality of the main bodies stacked together in a direction perpendicular to a plane in which the main bodies are arranged.

4. The connecting terminal according to claim 3, wherein at least two main bodies of the plurality of main bodies are abutted together, and at least a portion of the at least one cable is weldable onto a face of the outermost main body of the at least two main bodies located away from other main bodies of the at least two main bodies.

5. The connecting terminal according to claim 3, wherein at least a portion of the at least one cable is weldable between two adjacent main bodies of the plurality of main bodies.

6. The connecting terminal according to claim 5, wherein an insertion slot adapted to receive the mating terminal is formed between the electrical contacting portions of the two adjacent main bodies.

7. The connecting terminal according to claim 6, wherein at least a portion of the at least one cable is weldable onto a face of either main body of the two adjacent main bodies distal from the other main body.

8. The connecting terminal according to claim 1, wherein at least one side of opposite two sides of the main body is formed with a notch located between the welding portion and the electrical contacting portion and is adapted to engage with a terminal locking member to lock the connecting terminal.

9. The connecting terminal according to claim 1, wherein at least one side of opposite two sides of the main body is formed with a positioning protrusion protruding outward, the positioning protrusion located on a side of the welding portion proximate to the electrical contacting portion and adapted to engage with an insulating housing accommodating the connecting terminal.

10. The connecting terminal according to claim 1, wherein the connecting terminal is an integral conductive component.

11. An electrical connector comprising:
an insulating housing; and
a connecting terminal arranged within the insulating housing and defining a planar main body, including:
an electrical contacting portion adapted to electrically connect to a mating terminal; and
a welding portion connected to the electrical contacting portion and adapted to be welded to at least one cable.

12. The electrical connector according to claim 11, wherein the main body defines a first face and an opposite second face, the at least one cable is welded onto at least one of the first face or the second face.

13. The electrical connector according to claim 11, further comprising a plurality of the main bodies stacked together in a direction perpendicular to a plane in which the plurality of the main bodies are arranged.

14. The electrical connector according to claim 13, wherein at least two main bodies of the plurality of main bodies are abutted together, and at least a portion of the at least one cable is welded onto a face of the outermost main body of the at least two main bodies located away from other main bodies of the at least two main bodies.

15. The electrical connector according to claim 13, wherein at least a portion of the at least one cable is welded between two adjacent main bodies of the plurality of main bodies.

16. The electrical connector according to claim 15, wherein an insertion slot adapted to receive the mating terminal is formed between the electrical contacting portions of the two adjacent main bodies.

17. The electrical connector according to claim 15, wherein at least a portion of the at least one cable is welded onto a face of either main body of the two adjacent main bodies distal from the other main body.

18. The electrical connector according to claim 11, wherein at least one side of opposite two sides of the main body is formed with a notch located between the welding portion and the electrical contacting portion, the connecting terminal further including a terminal locking member engaging with the notch and preventing the connecting terminal from moving in a direction opposite to an insertion direction of the connecting terminal.

19. The electrical connector according to claim 18, wherein, with at least a portion of the at least one cable welded between two adjacent main bodies:
the terminal locking member includes a base and a protrusion extending outward from either end of the base, the protrusion engaging with the notch of the adjacent two main bodies; and
the terminal locking member further includes a spacing portion extending from the base portion and perpendicular to the base portion, the spacing portion positioned between the two adjacent main bodies.

20. The electrical connector according to claim 11, wherein at least one side of opposite two sides of the main body is formed with a positioning protrusion protruding outward, the positioning protrusion arranged on a side of the welding portion proximate to the electrical contacting portion and adapted to interfere with an insulating housing accommodating the connecting terminal.
